(19) United States
(12) Patent Application Publication
(10) Pub. No.: US 2023/0189403 A1
(43) Pub. Date: Jun. 15, 2023

(54) Electrically Isolating Support Element

(71) Applicant: Kelvin Thermal Energy Inc., Toronto (CA)

(72) Inventors: Amirhossein AHADI, Toronto (CA); George LYNCH, Escondido, CA (US); Aarik SUBRAMANYAM, North York (CA)

(21) Appl. No.: 18/166,397

(22) Filed: Feb. 8, 2023

Related U.S. Application Data
(63) Continuation of application No. PCT/CA2021/051183, filed on Aug. 26, 2021.

(30) Foreign Application Priority Data
Aug. 26, 2020 (CA) 3091177

(51) Int. Cl. H05B 3/16; H05B 3/14

(52) U.S. Cl. CPC H05B 3/16; H05B 3/145; H05B 2203/014

(57) ABSTRACT

The present invention is directed to high temperature energy storage arrangements that utilize electrical heating elements for charging a carbon-based heat retaining core. A high temperature electrically isolating support element is used to support a resistive heating element. The components are designed for extended life in a high temperature thermal core with frequent thermal cycling. The heat retaining core is of graphite or carbon based material that is electrically conductive. The electrically isolating support element reduces leakage current losses while providing high mechanical strength and effective heat transfer from the resistive heating element to the heat retaining core. The contact surface of the electrically isolating support element and the resistive heating element is limited while still providing effective mechanical support. The support element and heating element engage in a manner to locate and position the support element on the heating element.

### CROSS-REFERENCE TO RELATED APPLICATIONS

The present application is a continuation of International PCT Application No. PCT/CA2021/051183 filed Aug. 26, 2021, which claims priority from Canadian Application No. 3,091,177 filed on Aug. 26, 2020, both incorporated herein by reference in their entireties.

### FIELD OF THE INVENTION

The present invention is an electrically isolating support element in combination with a resistive heating element.

### BACKGROUND

The present invention is directed to high temperature energy storage arrangements that utilize electrical heating elements for charging a carbon-based heat retaining core. In particular the invention relates to the support and electrical isolation of the heating elements from the electrically conductive heat retaining core.

Our earlier U.S. Pat. No. 10,345,050 discloses a particular structure of the core in combination with a series of electrical heating elements that are designed to operate at elevated temperatures with the core subject to frequent large temperature cycling.

Overall energy efficiency in combination with extended life of the heating elements as well as low maintenance are key considerations for most applications. These considerations are challenging given the expected frequent thermal cycling of the core, the high upper temperature limit of the system and the large temperature differential that is likely to occur for each 1 temperature cycle. For many applications the frequent thermal cycling of the core will be at temperatures above 1000° C.

### SUMMARY OF THE INVENTION

The present invention, in a preferred embodiment is directed to the heating elements and the electrically isolating support thereof in the thermal core. Leakage current, heating element structure and ease of replacement directly impact the design of the system as described with respect to the preferred embodiment.

According to an aspect of the present invention a high temperature electrically isolating support element effectively cooperates with a resistive heating element to reduce leakage current from heating element through the electrical isolating support element to the electrically conductive heat retaining core. The isolating support element includes a narrow elongate slot passage sized to receive and straddle opposed edges of the resistive heating element. The support element includes a projecting landing within the slot for supporting a bottom surface of the resistive heating element at a raised position within the slot passage to limit the surface contact area of the resistive heating element and the support element.

In a preferred aspect of the invention the electrically isolating support element is of a two-piece construction. In a further aspect of the invention the two-piece construction is formed from the same one piece component with the components positioned in a reverse orientation.

According to an aspect of the invention, each support element includes at each side of the slot, a locating member that engages a side edge of the resistive heating element. This structure retains the support element in a given position along a length of the resistive heating element.

In a preferred aspect of the invention, each locating member projects inwardly and engages a shallow recess in the resistive heating element.

In a different aspect of the invention, the resistive heating element includes a plurality of connected traces and each trace is supported by the at least one projecting landing portion of the support element.

In a preferred aspect of the invention, the at least one projecting landing portion of the support element supports a portion of the width of each the heating element trace portion.

A preferred aspect of the invention, the support element has the projecting landing portions having an area of less than 10 percent of the interior surface area of the slot.

In an aspect of the invention, the high temperature electrically isolating support element is combined with a resistive heating element that includes at least 4 traces and the at least one projecting landing portion is two projecting landing portions with each landing portion supporting two adjacent traces.

According to a preferred aspect of the invention, each opposed member of the support element are of the same section and include a central locating structure to separate the center two traces of the resistive heating elements.

In an aspect of the invention, the support element provides limited edge support and captures the traces as they pass through the slot. The support element has limited direct contact with the resistive heating element to reduce leakage current.

In a further aspect of the invention, the resistive heating element is made of a CFC material and the support element is made of a boron nitride ceramic material.

In a preferred aspect of the invention, each support element includes a securing arrangement to one side of the support element and exterior to the slot.

Each outer trace, in a preferred aspect of the invention, includes a shallow tooth segment in a limited region of an outer edge thereof and the shallow saw tooth segment cooperates with the locating member of the support element to locate the heating element in the slot in a fixed position.

### BRIEF DESCRIPTION OF THE DRAWINGS

Preferred embodiments of the invention are shown in the drawings wherein:

FIG. 1 is a schematic view of the thermal storage matrix (prior art) shown in our earlier U.S. Pat. No. 10,345,050 that receives the electrical resistive heating elements and the isolating support elements shown in the following figures;

FIG. 2 is a perspective view of 12 electrical heating elements connected in series, positioned and secured in a heat retaining core;

FIG. 3 is a perspective view similar to FIG. 2 of resistive heating elements positioned for receipt in thermal core of larger capacity;

FIG. 4 is a perspective view of an isolating support element located on a resistive heating element;

FIGS. 5 and 6 are perspective views of the upper and lower surface of the component used to form the two pieces of the support element;

FIGS. 7 and 8 are a top view and a perspective view of the preferred shape of the resistive heating element; and

FIG. 9 is a partial enlargement of a heating element at a support position.

### DETAILED DESCRIPTION OF THE PREFERRED EMBODIMENT

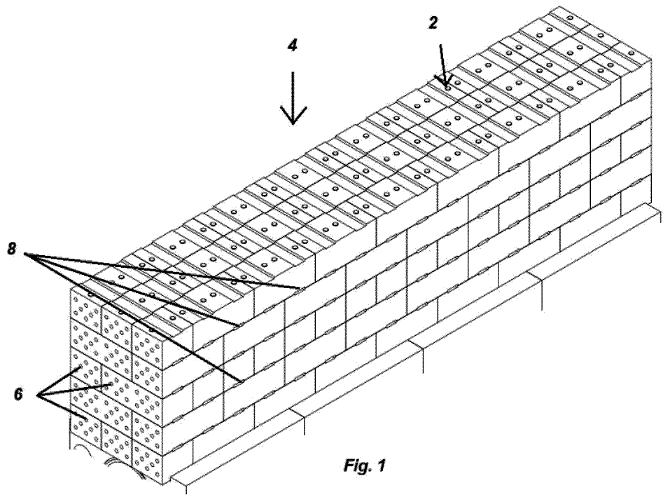

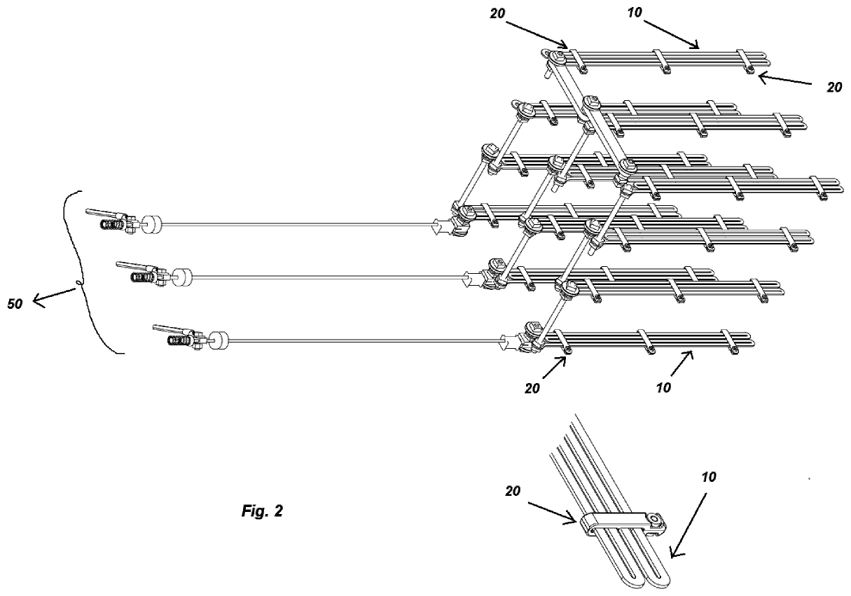

FIG. 1 provides a general overview of a thermal energy matrix system 2 used to store thermal energy and is designed to operate at temperatures in excess of 1000° C. although it can operate at lower temperatures. The matrix uses a graphite based thermal core 4 having a series of passages 6 distributed throughout the core that allow circulation of a controlled atmosphere through the core for energy output. The thermal core 4 includes a series of resistive heating element receiving ports 8 to locate the heating elements 10 (see FIG. 2) for effective heating of the core to temperatures well in excess of 1000° C. For example, in a first embodiment of the system, the upper limit is about 1450° C. and in a second embodiment the upper limit is in excess of 2000° C. preferably about 2450° C.

FIGS. 2 through 8 provide details of the effective support of the heating elements electrically isolated from the thermal core while the resistive heating elements are in close proximity to the thermal core for effective heat transfer. The electrical isolation of the heating elements includes consideration of effective heat transfer and space utilization of the overall system. Electrical isolation is only one of several key factors in the efficient operation of the overall system. The graphite or carbon-based core is suitable for the desired high temperature applications and beyond. The core has good thermal conductivity and high mechanical strength and stability throughout the elevated operating temperature range. The core is also electrically conductive and may be directly grounded such that the resistive heating elements 10 need to be electrically isolated from the core while maintaining effective heat transfer. If the core is not directly grounded leakage current through the core is still possible and reduced by the present system.

As shown in FIG. 2, each resistive heating element 10 includes a plurality of electrically isolating support elements 20 separating the heating elements from the thermal core. Each support element 20 includes a first member 22 and a second member 24 that cooperate in an opposed orientation to define the narrow elongate slot 26 therebetween. These members engage in a limited manner, opposed edges 42 and 44 of the resistive heating element and form a band about the resistive heating element. The contact area between the heating elements and the support elements is reduced as much as practical to reduce leakage current and to provide a more uniform heating profile that increases the life expectancy of the heating elements. The support elements provide limited edge support and capture the heating element as it passes through the slot with the heating element having limited direct contact with the support element and spaced therefrom.

The resistive heating elements are connected to electrical inputs 50 that receive power typically from either a controlled 3 phase AC or DC electric power input.

The electrically isolating support elements can be made of an alumina ceramic material for applications under about 1250° C. or can be made of boron nitride ceramic material for higher temperature applications up to about 2250° C. Each of these materials provide high electrical resistivity and are tolerant with respect to frequent high temperature thermal cycling. Some care is required with the boron nitride ceramic isolator as it can be more fragile. Each of these isolators cooperate with the heating elements to limit electrical current leakage and provide improved efficiency. The manner of supporting and engaging each resistive heating element limits the size of the contact area and the resistive heating elements provide a more uniform heating profile increasing the life expectancy of each heating element. The heating elements are essentially spaced from the slot as they pass centrally through the slot while maintaining a close position to the thermal core. Longer life is an important consideration as the heating elements form a major cost component of the system and replacement of the heaters involves considerable down time and labour expense.

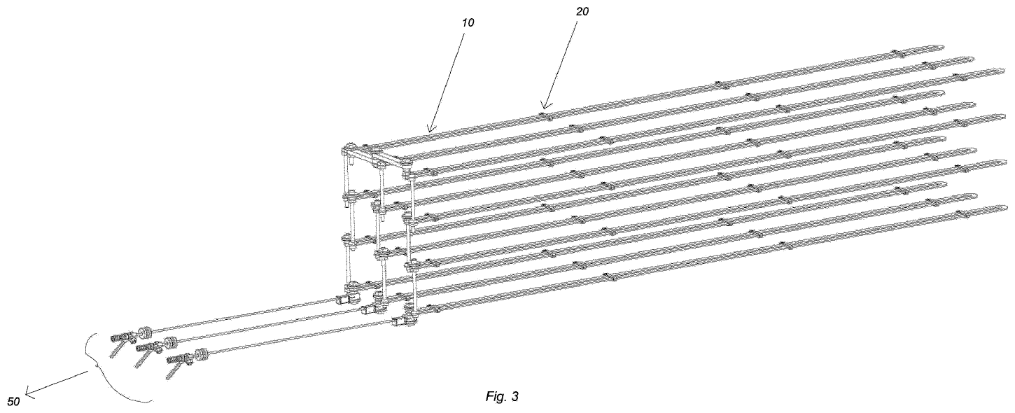

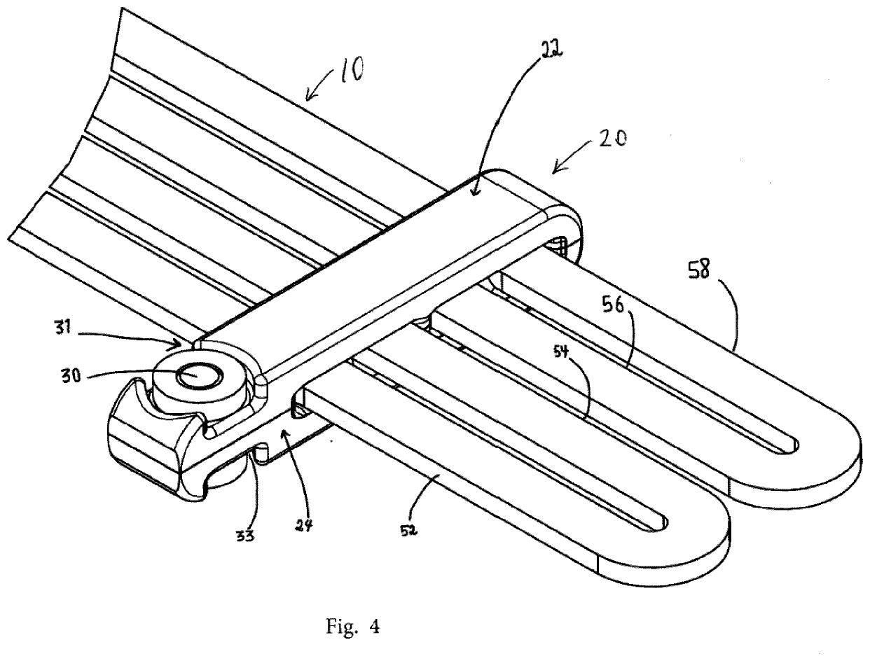

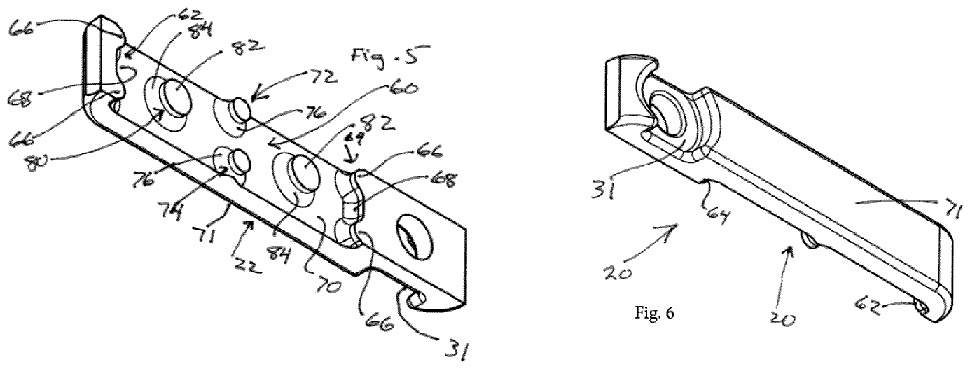

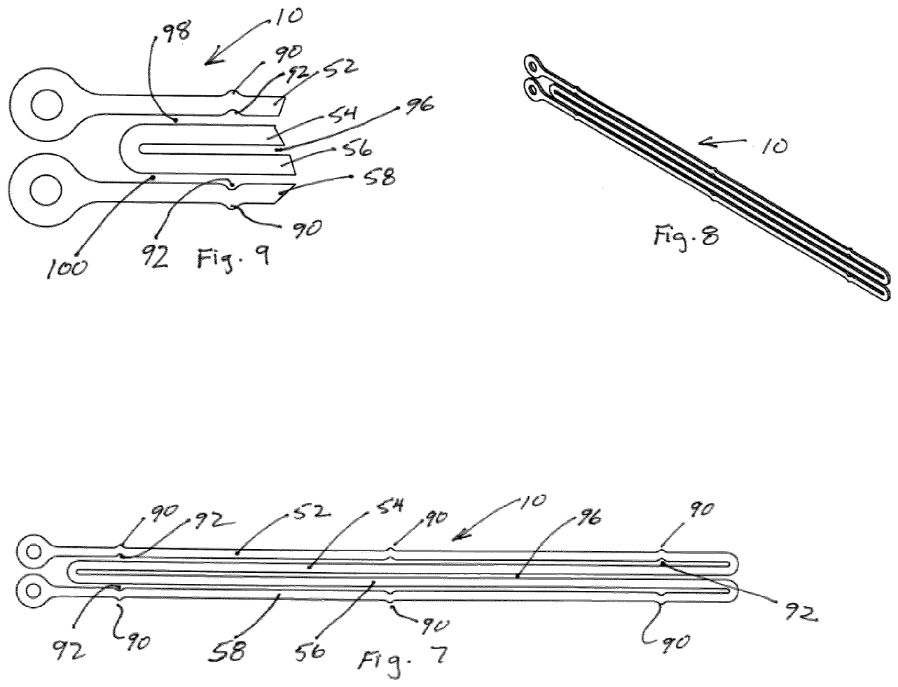

FIGS. 4, 5 and 6 provide details of the resistive heating element 10 and one of the support elements 20 located adjacent a free end of the heating element 10. Each support element 10 includes the first member 22 and the second member 24 secured exteriorly at one edge of the resistive heating element by securing member 30 received in outwardly opening recesses 31 and 33 of the respective first and second members. The securing member is generally flush with the upper and lower surfaces of the support element 20. This configuration simplifies the slot configuration in the thermal core and positions the securing member 30 to one side of isolating support element 20 and spaced from the heating element 10. This structure simplifies initial construction of the system and future replacement.

As shown in FIGS. 5 and 6, the first members are preferably the same component. For purpose of these figures it is described as first member 22 but the description equally applies to the second member 24. First member 22 is designed to provide limited edge support of the individual traces 52, 54, 56 and 58 at apposition spaced from planar surface 70. Each heating element 10 includes notched regions 12 that are engaged by and cooperate with the first member 22 to locate and support the traces of the heating element. The traces essentially are maintained in a position spaced from each other with limited direct surface contact with the support element.

First member 22 includes central recess 60 sized to cooperate with an opposed member to receive the 4 traces 52, 54, 56 and 58 captured therebetween and spaced therefrom. Opposed edges 62 and 64 of the recess 60 include projecting segments 66 and a central indentation 68 that increase in width downwardly to support the outer trace above the planar surface 70. The support position is such that each first member accommodates more than half of the thickness of the heating element and the trace elements are spaced from and not in direct contact with the planar surface 70. In contrast support surface 71 is in direct contact with the thermal core and will be at the temperature of the thermal core and below the temperature of the heating elements.

Recess 60 includes two small central supports 72 and 74 that increase in width in a direction towards planar surface 70. Each support 72 and 74 includes an enlarged base 76 that engages and locates the heating element at the gap 96 between traces 54 and 56. The gap 96 is slightly larger than the diameter of each support 72 and 74 above base 76. Therefore supports 72 and 74 locate and support traces 54 and 56 in the slot and base 76 positions the traces spaced above planar surface 70 and centrally in recess 60. Outer traces 52 and 54 on an outside edge thereof include a projection 90 having a corresponding recess 92 on the opposite edge of the trace. Projections 90 and recesses 92 occur at each position in the length of the heating elements 10 used to engage with support element 20.

Recess 92 in combination with the gap 98 between trace 52 and trace 54, defines sufficient space to partially receive and engage support 80. The top portion 82 of support 80, is closely received in this space with the base 84 supporting the traces spaced from planar surface 70. Support 82 to the other side of supports 72 and 74 supports traces 56 and 58 in a similar manner. With this arrangement limited edge support of the traces allows the traces to be generally out of direct contact with the support elements. This is desired even though the support elements have good electrical resistivity.

The outwardly extending projections 90 are located in the central indentations 68 of the support element. Projecting segments 66 locate the edges of the outer traces and an enlarged base supports the traces spaced from planar surface 70. With this arrangement the amount of direct surface contact between the support elements 20 and the traces of heating element 10 is quite small and the amount of leakage current is reduced.

Each outer trace at a support position, includes a projection 90 on an outer edge of the trace and a corresponding gap 92 on the opposite inside edge of the respective trace of heating element 10. With this arrangement the top and bottom surface area of the trace remain essentially the same throughout the length of the trace. Furthermore, the heating profile of each trace of heating element 10 is essentially the same while providing a preferred support function and locating function with the isolating support elements 20.

FIG. 9 is a partially enlargement of a portion of the heating element 10 at a support element 20 position.

The particular materials for the support elements provide high mechanical strength and high electrical resistivity for this particular high temperature application. The manner of supporting the trace elements of the heating elements in the support members provides effective support and positive engagement of the traces while reducing direct surface contact area. This provides an effective balance between reduced leakage current, effective support of the trace elements and close proximity of the trace elements to the thermal core without having large variations in the heat profile of the individual traces. As the length of the heating elements is increased more support elements may be provided. The heating elements having 4 closely placed connected traces, is space efficient and effective in transferring heat energy and maintaining the capacity of the thermal core. The support elements 20 due to engagement with the traces, remain in position when the heating element 10 is inserted in the thermal core and maintain the heating elements out of direct contact with the thermal core.

Although preferred embodiments of the invention have been described in detail for a better understanding of the invention, the claims of the application set out the protection the applicant seeks to obtain an exclusive right.

1. A high temperature electrically isolating support element in combination with a resistive heating element, said isolating support element comprising two opposed members defining a narrow elongated slot passage therebetween sized to receive and straddle opposed edges of said resistive heating element; with at least one of said opposed members including a projecting landing portion within said slot for supporting a bottom surface of said resistive heater at a raised position within said slot passage to limit the direct contact area of said resistive heating element and support element.

2. A high temperature electrically isolating support element in combination with a resistive heating element as claimed in claim 1 wherein said opposed members are of the same section.

3. A high temperature electrically isolating support element in combination with a resistive heating element as claimed in claim 1 wherein at least one of said support element includes at each side of said slot, a locating member that engages a side edge of said resistive heating element locating and retaining said support element in a known position in a length of said resistive heating element.

4. A high temperature electrically isolating support element in combination with a resistive heating element as claimed in claim 3 wherein each locating member projects inwardly and engages a shallow recess in said resistive heating element.

5. A high temperature electrically isolating support element in combination with a resistive heating element as claimed in claim 4 wherein said resistive heating element includes a plurality of connected traces and each trace is supported by said at least one projecting landing portion.

6. A high temperature electrically isolating support element in combination with a resistive heating element as claimed in claim 5 wherein said at least one projecting landing portion supports only a portion of each trace portion.

7. A high temperature electrically isolating support element in combination with a resistive heating element as claimed in claim 6 wherein said at least one projecting landing portion has an area less than 10 percent of the area of said slot.

8. A high temperature electrically isolating support element in combination with a resistive heating element as claimed in claim 7 wherein said resistive heating element includes at least 4 traces and said at least one projecting landing portion is two projecting landing portions with each landing portion supporting two adjacent traces.

9. A high temperature electrically isolating support element in combination with a resistive heating element as claimed in claim 8 wherein each opposed member of said support element are of the same section and include a central locating structure to separate the center two traces of said resistive heating elements.

10. A high temperature electrically isolating support element in combination with a resistive heating element as claimed in claim 9 wherein said resistive heating element is made of a CFC material and said support element is made of a boron nitride ceramic material.

11. A high temperature electrically isolating support element in combination with a resistive heating element as claimed in claim 10 wherein said support element includes a securing arrangement to one side of said support element.

12. A high temperature electrically isolating support element in combination with a resistive heating element as claimed in claim 11 wherein each trace includes a shallow saw tooth segment in a limited region of each edge thereof and said shallow saw tooth segment cooperates with said locating member of said support element.

13. A high temperature thermal energy storage system comprises a thermal core of a carbon based or graphite material with a series of electrical resistive heating elements located in slotted ports located in a distributed manner in the core; said series of electrical resistive heating elements having capacity to heat said thermal core to temperatures in excess of 1400° C.; each electrical resistive heating element including a plurality of isolating support elements spaced in a length of the electrical resistive heating element to support the electrical resistive heating element within one of said slots and out of direct contact with the thermal core and providing electrical isolation therefrom; each isolating support element comprising two opposed members defining a narrow elongated slot passage therebetween sized to receive and straddle opposed side edges of the respective resistive heating element; and wherein at least one of said opposed members of each isolating support element includes a projecting landing portion within said slot supporting a bottom surface of the respective resistive heating element at a raised position within said slot passage to limit the direct contact area of the electrical resistive heating element and support element.

14. A high temperature thermal energy storage system as claimed in claim 13 wherein said opposed members of each isolating support element are of the same section.

15. A high temperature thermal energy storage system as claimed in claim 13 wherein at least one of said support elements includes at each side of said slot therein, a locating member that engages a side edge of the respective resistive heating element locating and retaining said isolating support element in a known position in a length of said resistive heating element.

16. A high temperature thermal energy storage system as claimed in claim 15 wherein each locating member projects inwardly and engages a shallow recess in said resistive heating element.
